(19) United States
(12) Patent Application Publication
(10) Pub. No.: US 2004/0109408 A1
(43) Pub. Date: Jun. 10, 2004

(54) Fast protection for TDM and data services

(75) Inventors: Michael Mesh, Kfar Saba (IL); Yuval Porat, Tel Aviv (IL); Irit Shahar, Raanana (IL)

Correspondence Address: Ira J. Schultz, DENNISON, SCHULTZ & DOUGHERTY, Suite 612, 1745 Jefferson Davis Highway, Arlington, VA, 22202, US

(73) Assignee: PacketLight Networks, Ltd.

(21) Appl. No.: 10/310,940

(22) Filed: Dec. 6, 2002

(51) Int. Cl. G01R 31/08

(52) U.S. Cl. 370/222; 370/223

(57) ABSTRACT

A method and system for protecting packets which include services, transported over an optical communication network, against traffic loss of more than 50 milliseconds, the method including: selecting a sub-network of the network; defining a protection scheme in the sub-network; utilizing a standard protocol for failure detection and identification and protection; defining connections between an A side and a Z side in the network, passing through at least one selected network element in said sub-network; automatically adding entries in switching tables of said selected network elements for a working state of said sub-network connections; and adding pre-defined entries in said switching tables for a protection state for each network element in the sub-network.

### FIELD OF THE INVENTION

The present invention relates to multi-service protection for packets transmitted over optical fibers.

### BACKGROUND OF THE INVENTION

Synchronous Optical Networks (known as SONET or SDH) are in wide use at present for transmitting services in channels over optical fibers in a communications network. SONET networks provide fast protection against traffic loss to these channelized SONET services. Typically, channelized SONET services include a number of Synchronous Transport Signal-level 1 (STS-1). Each STS has a bit rate of 51.840 megabit per second. The STSs are sent over the optical fiber. Since the SONET services are synchronized, it is crucial that no bits be lost during transmission, in order to permit accurate reception of the transmitted services.

Conventional network topologies are illustrated schematically in FIGS. 1a, 1b, 1c and 1d. FIG. 1a shows a simple linear point-to-point topology. FIG. 1b shows a ring topology. FIG. 1c shows one example of a mesh topology, including both ring topology and point-to-point. A cross-connect is provided in this topology for traffic transported from and to the ring. FIG. 1d shows another example of a mesh topology.

Each node in each of these topologies includes both a transmitter and a receiver for two-way transmission of traffic. Generally, a separate fiber is utilized for traffic in each direction. One half of the total available bandwidth, in the time dimension, in each topology is reserved for protection, if protection is applied

In case of failure in the system, i.e., the optical fiber is cut, or one of the transmitters or receivers fails, or the line is noisy (or any other failure defined for SONET systems), traffic directed through the failed link is cut off. Accordingly, it is crucial to provide some sort of protection scheme to determine if there is a failure and to provide another route for the traffic, without traffic loss, when communication is cut off. SONET protection guarantees traffic loss of no more than 50 milli-seconds in a ring or linear point-to-point topology, by which time the protection channel takes over and continues the transmission.

Conventional SONET protection for a linear point-to-point system is called Automatic Protection Switch (APS). In linear APS, there are two channels: working and protecting. Each node selects the received traffic from the working channel, unless a problem is detected. If a failure is detected, traffic is selected from the protecting channel, instead of from the working channel.

SONET APS architecture supports two types of system architecture: 1+1, wherein traffic is duplicated to both a working and protecting channel in the transmitting side, and the receiving side selects the right channel; and 1:1, wherein the protecting channel is transmitting the working traffic only in case of Protection Switch and therefore can be used to carry extra traffic in the working state (while the Protection Switch is not activated). A typical prior art 1+1 APS system is illustrated schematically in FIG. 2. As can be seen, the traffic (data and overhead) between the SONET network elements (NE) 10, 12 is duplicated, i.e., sent twice, over both a working channel W and a protecting channel P. Network element 10 transmits traffic on W and P. Network element 12 transmits traffic on W′ and P′. A selector 14, 14′ is provided in each network element to select the channel to be used.

In case of a problem with reception of traffic over the regular working channel, the affected network element selects the protection channel, i.e., protection is provided in the line layer. In this case, all the STS's are switched simultaneously, so that all the SONET traffic is protected together. There is no extra traffic capability in this system, since the protection and working channels carry the same traffic. The selector selects between the working and protecting channels according to pre-defined switching criteria upon detection of signal failure or signal degradation. Generally, the switching criteria include loss of signal, loss of frame, high bit error rate, and Alarm Indication Signal at the line level (AIS-L). Two bytes, K1 and K2, are reserved in the SONET frame Line OverHead (LOH), and are known as “APS Channel”. In the 1+1 architecture, they are mainly used by the APS protocol to indicate the network element status.

The 1:1 architecture is a more enhanced architecture, which permits the use of the protecting channel to carry extra traffic, as long as there is no signal failure or degradation. In case there is a problem in the working channel, the protection switch takes over, and the extra traffic is dropped. In 1:1 architecture, besides status, the APS protocol is used to activate APS in the remote network element by means of APS requests initiating the switch between the working and the protection channels.

SONET ring protection architectures support mainly Unidirectional Path Switched Rings (UPSR) (Telcordia Standard GR-1400) and Bi-directional Line Switched Rings (BLSR) (Telcordia Standard GR-1230). Line protection is provided in BLSR, while path protection is provided is UPSR. In UPSR, traffic is transmitted concurrently on two different rings (working and protection), and the working routes are unidirectional (i.e., working and protection operate in opposite directions). There is no extra traffic capability. Traffic is selected from the Working channels, unless a path failure or line failure is detected. When the network element detects signal failure or signal degradation, it inserts an alarm indication signal at the path level (AIS-P) to the affected paths. However, only the path termination node may switch the path.

FIG. 3 is a schematic illustration of a typical prior art BLSR network. This architecture includes bi-directional switching, and provides line protection. Extra traffic is optional, i.e., it will be lost in case of actuation of Protection Switch. The K1, K2 protocol is essential, and is used for managing the Protection Switch in the ring. The Protection Switch protocol is transmitted between the failure edge nodes over K1, K2 in both directions. The use of extra traffic is also announced through K1 and K2. In this architecture, one half of the STS's in each link are marked as the Working channel, and one half as the Protection channel.

Upon detection of signal failure or signal degradation, the K-byte protocol activates the Protection Switch. If the PS protocol is completed successfully, the edge nodes wrap around working traffic which was directed to the failed link, to the reserved protecting STS's. In addition, incoming protecting channel traffic, which is not directed to that node itself, is wrapped around, back to the working channel, as illustrated schematically in FIG. 4. Thus, in the attached example:

Traffic that should have been sent from NE#1 to NE#2 on the working channel, is directed to NE#2 through NE#3 and NE#4, on the protecting channel;

Traffic that should have been sent from NE#2 to NE#1 on the working channel, is directed to NE#1 through NE#4 and NE#3, on the protecting channel;

NE#1 and NE#2 extract their traffic from the protecting channels;

The other ring nodes learn from the K-byte protocol that Protection Switch is operating in the ring;

The traffic (STS's) on the protecting channel merely passes through the other nodes, and, therefore, the only concern of such passing through nodes with Protection Switch is the drop of extra traffic;

The edge nodes (NE#1 and NE#2, in the example of FIG. 4) communicate through the K-byte protocol.

Current 50 msec protection systems operate on SONET, and therefore usually provide protection only for synchronized services (channelized frames), (although they may support protection for Packet Over SONET/SDH (PoS) over isolated linear APS topology). No standard exists today to define protection for Packet over SONET (or SDH) in Ring or Mesh topologies: conventional SONET BLSR or UPSR APS are insufficient.

RPR, which is an evolving protocol, isdefining protection for packet ring Currently, in RPR both SONET layer, MAC layer and an additional complex signaling protocol are required. The topology is restricted to ring, and SONET/PDH high bit rate services are not well supported

On the other hand, data networks either do not provide protection at all, or use slow network mechanisms for protection. In IP (Internet Protocol) networks (layer 3), link failures are detected after several seconds, and an alternative route (OSPF) is found within a minute. The newly found route involves updating the switching/routing table.

Ethernet (layer 2) defines protection (IEEE 802.3ad) of up to one second traffic loss.

Accordingly, there is a long felt need for a protection system for data services, and mixed SONET and data services, which is relatively simple to implement and which guarantees no more than 50 msec traffic loss.

### SUMMARY OF THE INVENTION

The present invention provides a fast protection service (50 msec) for both synchronized and non synchronized services, without the need for signaling, beyond the simple SONET standard K-Byte Protocol. The 50 msec protection is supported in any conventional topology, including ring, linear Point-to-Point, and mesh topology.

Alternatively, other protocols besides SONET or its equivalent SDH, such as OTN, may be used by the system. PoS may be easily replaced by GFP or any other layer 1 protocol

Another protection method supported is optical protection, in which the whole wavelength is protected. Optical protection is especially suitable for protection of non-SONET wavelength services.

There is thus provided in accordance with the present invention a method for protecting packets which include services, transported over an optical communication network, against traffic loss of more than 50 milliseconds, the method including: selecting a sub-network of the network, defining a protection scheme in the sub-network; utilizing a standard protocol for failure detection and identification and protection; defining connections between an A side and a Z side in the network, passing through at least one selected network element in said sub-network; automatically adding entries in switching tables of said selected network elements for a working state of said sub-network connections; and adding pre-defined entries in said switching tables for a protection state for each network element in the sub-network.

According to a preferred embodiment, the method further includes adding pre-defined entries to the switching table for each network element for selected alternative states of the sub-network.

For purposes of the present application, the term “switching table” is used to refer to a plurality of pre-defined routes for each connection in the sub-network. One route is used to define the working state and other routes may define alternative routes for other states of the network, such as Protection switch, degradation, etc.

According to a preferred embodiment of the invention, the method further includes pre-defining entries for every “extra traffic” connection for discarding the traffic in case of degradation in the sub-network the connection passes through.

According to a preferred embodiment, the method further includes actuating Protection Switch in the sub-network including selecting one of an already existing protection path pre-defined in the switching tables.

Further according to a preferred embodiment, the method further includes using conventional SONET including Signal Fail (SF)/Signal degrade (SD) identification and APS/BLSR protocols over K1, K2 channel.

There is also provided according to the present invention a system for providing protection for services transmitted over an optical communication network from an A-side to a Z-side against traffic loss of more than 50 milli-seconds, the system including a sub-network including a plurality of network elements; at least one connection between said A-side and said B-side passing through at least one network element in said sub-network; a switching table indicating a working state for each said connection; and at least one Protection Switch indicator including at least one entry in the switching table indicating a pre-defined protection path between each two network units.

### BRIEF DESCRIPTION OF THE DRAWINGS

The present invention will be further understood and appreciated from the following detailed description taken in conjunction with the drawings in which:

FIGS. 1a, 1b, 1c, and 1d are schematic illustrations of examples of conventional topographies;

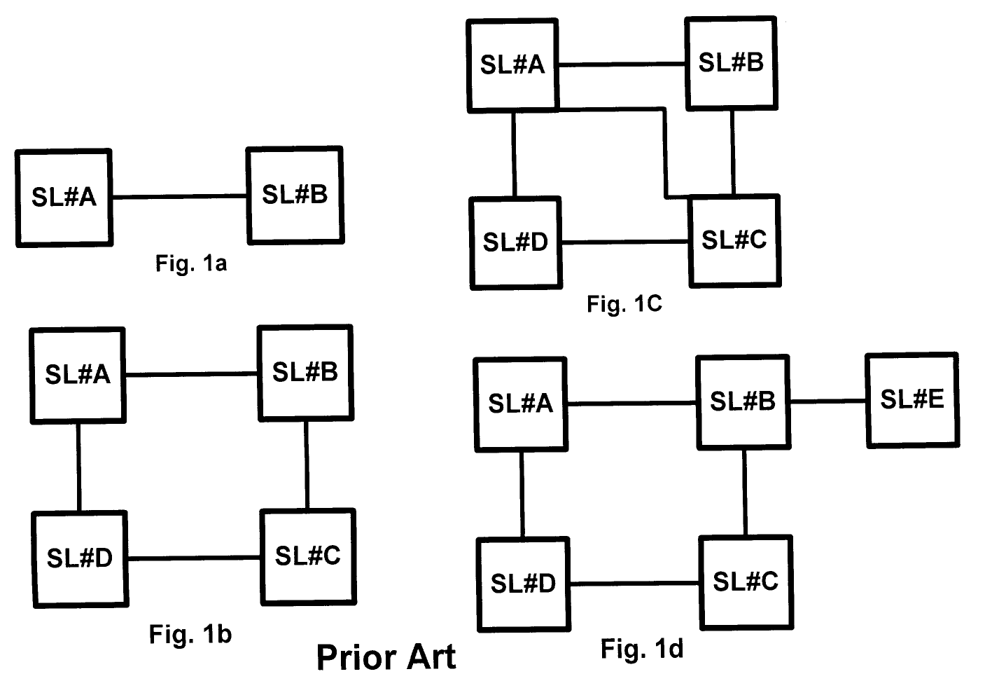

FIG. 2 is a schematic illustration of a typical prior art linear APS system;

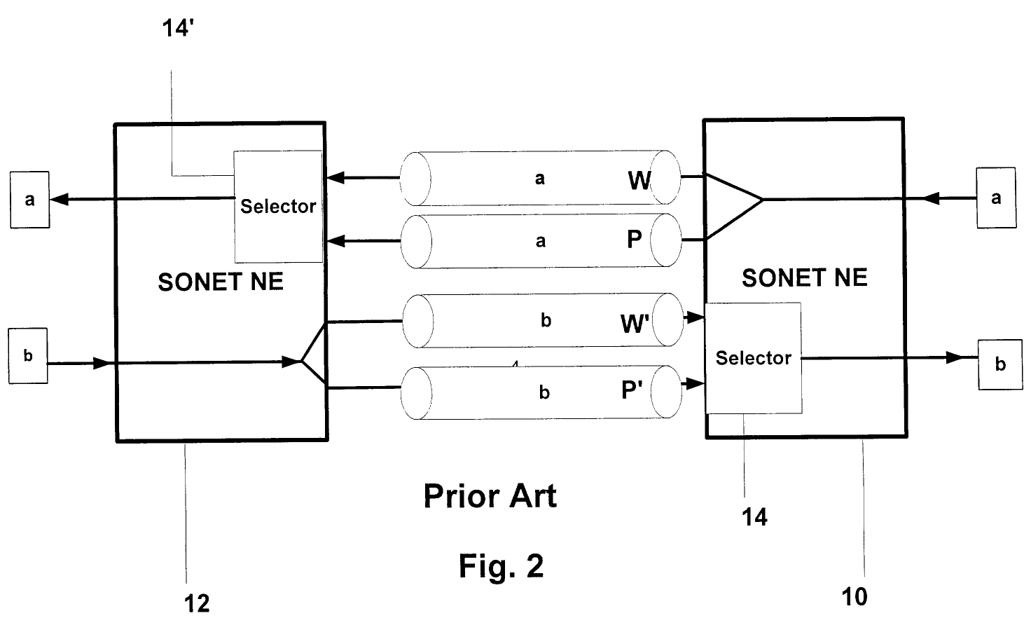

FIG. 3 is a schematic illustration of a typical prior art ring BLSR system;

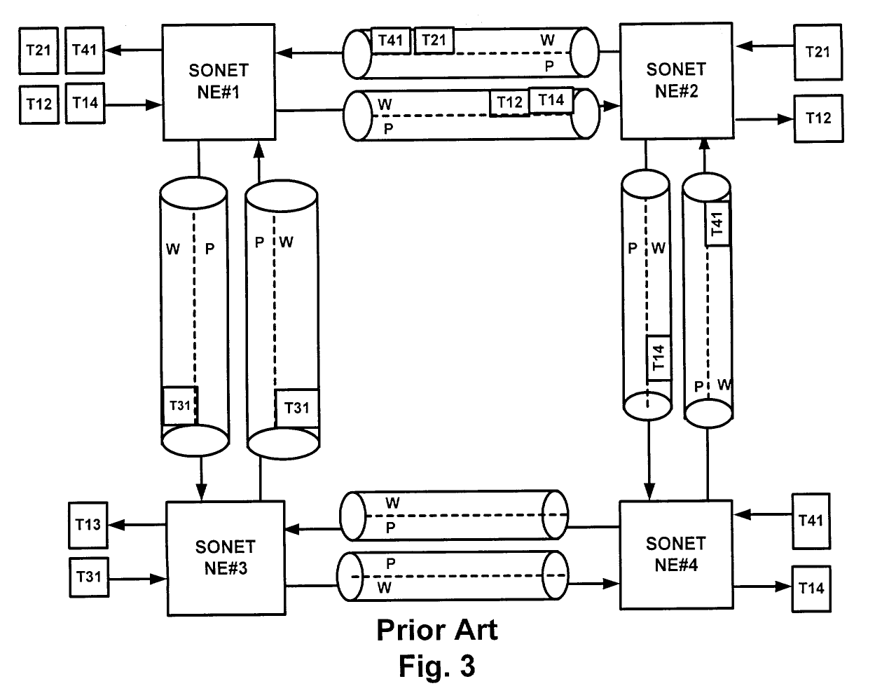

FIG. 4 is a schematic illustration of the system of FIG. 3 in the protecting state;

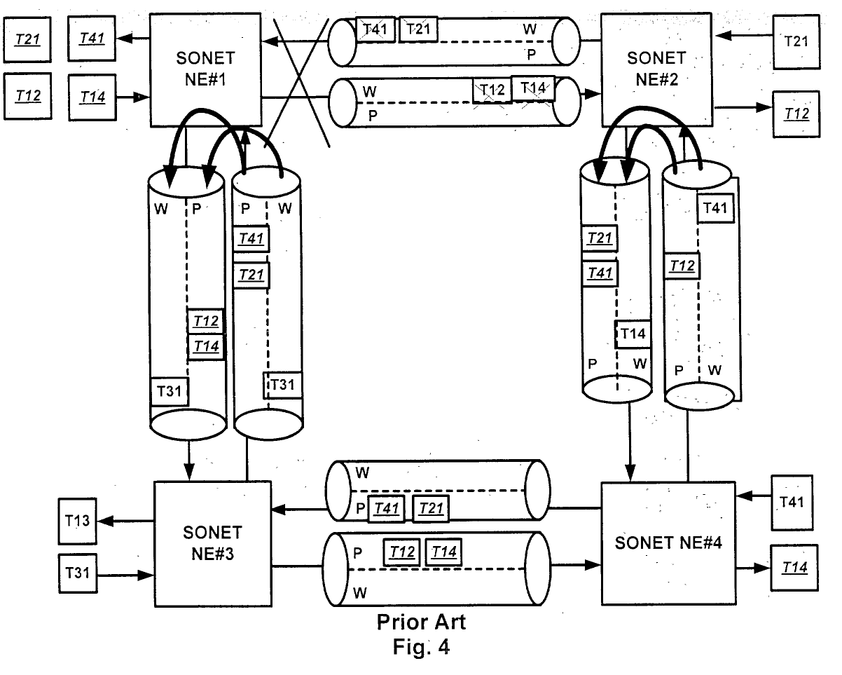

FIG. 5 is a schematic illustration of a switching table according to the present invention;

FIG. 6 is a schematic illustration of protected linear topology, according to one embodiment of the invention;

FIG. 7 is a schematic generic illustration of a protected linear topology in working and in protecting states;

FIG. 8 is an example of one embodiment of a switching table of a system of FIG. 6 according to the invention;

FIG. 9 is a schematic illustration of protection for a ring configuration (BLSR), according to one embodiment of the invention;

FIG. 10 is a schematic illustration of the system of FIG. 9 in the protecting state;

FIG. 11 is an example of one embodiment of a switching table of a system of FIG. 9 according to the present invention;

FIGS. 12a, 12b, 12c, and 12d provide a schematic comparison between average route length in Protection Switch in conventional SONET and in the present invention; and

FIG. 13 is an example of one embodiment of a PS mapping of a system of FIG. 9 according to the present invention.

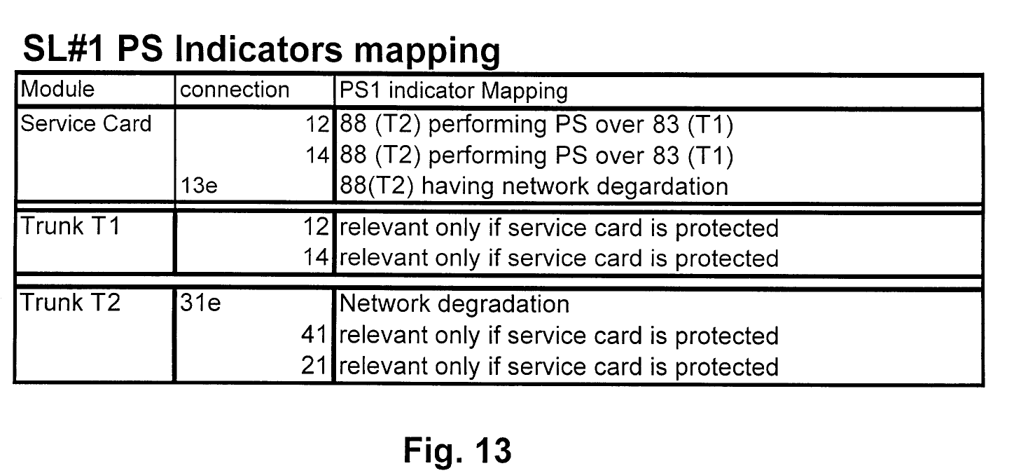

### DETAILED DESCRIPTION OF THE INVENTION

The present invention relates to a system and method for providing fast protection (50 msec) against data loss in a fiber optic communication network for wavelength services, SONET services (channelized or concatenated), data services or others, using optical layer only (for lambda) or Packet Over SONET (PoS) or any other standard layer 1 protocol as required, without any need for signaling, beyond the simple, standard SONET K-Byte protocol. It is a particular feature of the invention that any topology is supported: ring (BLSR and UPSR), linear point-to-point (1:1 and 1+1), and combinations. In any of these topologies, the connection (for transport of traffic between selected service ports in the network) may either be protected (usually voice), degraded rate (degrade under Protection Switch to a minimum pre-defined rate), unprotected (usually Best Effort Ethernet traffic), extra traffic (discarded upon failure in the protected channel), or any other. The protection is fast Protection Switch, so the traffic loss time is at most 50 msec from failure identification.

Another feature provided by the present system is the capability to add/remove a node from a ring without affecting the traffic, as possible at present in SONET networks, but not in data networks.

The guidelines of the invention are:

Separation of the protection layer from the switching layer.

Utilizing static switching tables in the switching layer, the switching tables including pre-defined states: working states, protection switch state and other states as desired (i.e., the switching tables do not change when the Protection Switch is activated).

Use of the conventional SONET layer for failure detection and simple K-byte protocol, or other corresponding failure identification and protection protocol.

The protection layer is responsible for:

1) failure detection and identification (e.g., signal failure, signal degradation),

2) Initiation and managing of Protection Switch protocol

3) Providing a set of indicators to the switching layer. Each indicator is associated with a certain event (like Protection switch) for every connection. Failure detection and identification is provided by using the SONET layer (GR.253, GR.1230, or other corresponding failure identification and protection protocol.

It is a particular feature of the present invention that, in order to support protection, each involved trunk port (trunk is associated with link) in each network element has a mate. Both are needed for supporting Protection. Service cards may also have mates in order to support service side protection.

Mates (trunks or service cards) must communicate between themselves in order to manage the Protection Switch correctly. Communication is carried out through the backplane via inter-card protocols.

Initiation of PS is provided by an internal control protocol between any two mates (working and protecting pair) in a node participating in the protection scheme. Providing PS state indications to the switching layer is done by an internal protocol between all line cards that comminicates the PS state and the degradation state of any trunk or service card to all other line cards. The input given to the switching layer from the protection layer is: For any output trunk, indication if this output is currently in working state, protection switch state or degraded state

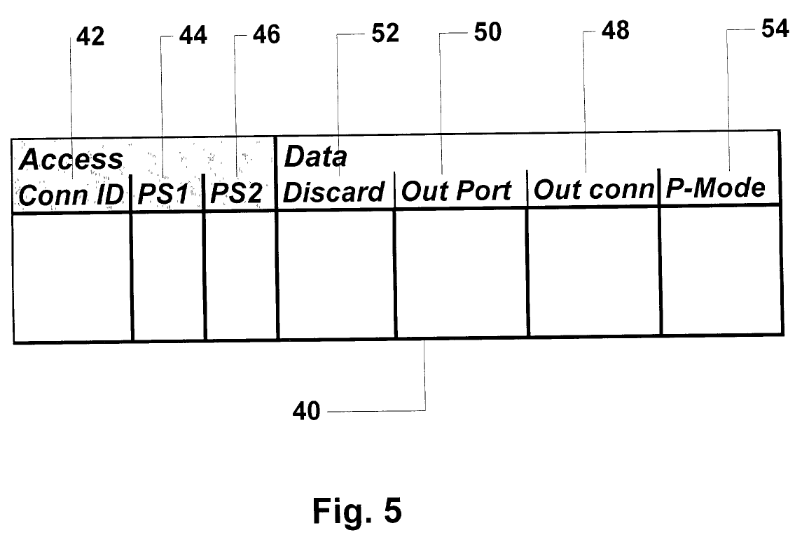

The Switching Layer will now be described in detail. One example of a Switching table for packets according to the invention is shown in FIG. 5. The switching table 40 is accessed according to connection ID 42 and a set of indications, here shown as PS1 44 and PS2 46, usually mapped to indicate Protection switch or degradation. The number of indications for accessing the switching table may be increased as required. For each connection, each indicator may be mapped to either protection switch indication or degradation indication. Any other event, if desired, may also be mapped to the indicators.

The main output data parameters are as follows. Output connection ID 48 replaces the input connection ID 42 (as in MPLS networks). Out port entry 50 indicates the output port that the data will be transmitted on. Discard indication 52 indicates whether the data is to be discarded or not. Additional parameters may be included in the switching table as required. For example, P-mode 54 is relevant for BLSR ring, and indicates that the packet is wrapped around.

The entry for working state, for a certain connection, is the entry when PS1,PS2, etc.=0. PS1=1,PS2=0 describes the state where PS1 is set, and so forth.

It is a particular feature of the invention that the switching table is pre-configured for all Protecting Switch, Degradation, or other selected pre-defined states, and therefore the designer determines in advance what the system should do in any case. Unlike conventional routers, the present invention utilizes a static switching table, which is not changed or updated during Protection Switch. (Connection entries may be added or deleted while adding or removing connections to the system.)

It is a particular feature of the invention that there is no central card or node which indicates a problem, but rather any line card which performs protection on its mate can send Protecting Switch signals. In addition, every line card receives Protecting Switch signals from all the other line cards and, thus, knows which ports are in working state, which are in Degradation state (where extra traffic is dropped) and which are in Protection Switch state (where traffic is directed to the Protecting channel, rather than the Working channel).

Preferably, the system utilizes the conventional SONET frame and framer for SONET transport, termination, for K-byte protocol, and for failure detection aspects in the fast protection support. K-byte protection protocol (conventional SONET protocol), or another protection activation protocol, is utilized for communication between network elements, for applying Protection Switch in APS and BLSR

The present invention utilizes a switching table in the switching layer, a layer which operates regardless of the type or characteristics of the services in the packets. The switching table is pre-configured, for every connection, with the connection data (i.e output port, output label, discard indication, etc.) in the working state, and in up to a few independent states, indicated by a set of indicators (PS indicators). An indicator may be assigned per connection to Protection switch (PS), Degradation or any other state, as required. The switching table, here, replaces the switching table in Data networks or the STS XC matrix in TDM network, which do not contain any PS data.

In order to provide the indicators PS1,PS2, etc per connection, for every connection, the values of the Protection Switch or degradation signals that set PS1, PS2 are pre-configured in a mapping table which is associated with the switching table

The inter line cards protocol transmits to all line cards information regarding which port is performing PS at any moment. This data is compared with the mapped PS parameters of a connection entering the switching table, generating PS1,PS2, i.e., for a certain connection,PS1=1, if PS1 is mapped to Port X performing Protection Switch and port X is performing PS. if PS2 is mapped, for a certain connection, to degradation on port Y, PS=1 for this connection upon Port Y having degradation. Thus, if a packet belonging to Conn ID X arrives, in the working state, the output port, connection ID, and discard bit data will be extracted from the table entry of (ConnX, PS1=0, PS2=0). In the protecting state, assuming PS1 is on, the output port connection ID and discard bit data are extracted from the table entry of (Conn X, PS1=1, PS2=0).

Switching tables are distributed in all Line cards. Each line card maintains its own connections'Switching tables. The working channels'switching tables are mirrored in the protecting channels'tables. The protecting channels'switching tables also include all the extra traffic connections, which are dropped in case of entering into Protection Switch. The drop is carried out through the switching tables. This is achieved by mapping the PS indicator to degradation and setting the switching table for extra traffic with a discard indication (discard=1) in the case of PS1 or PS2=1.

The following sections detail the behaviour of the protection system of the invention in exemplary APS & ring schemes.

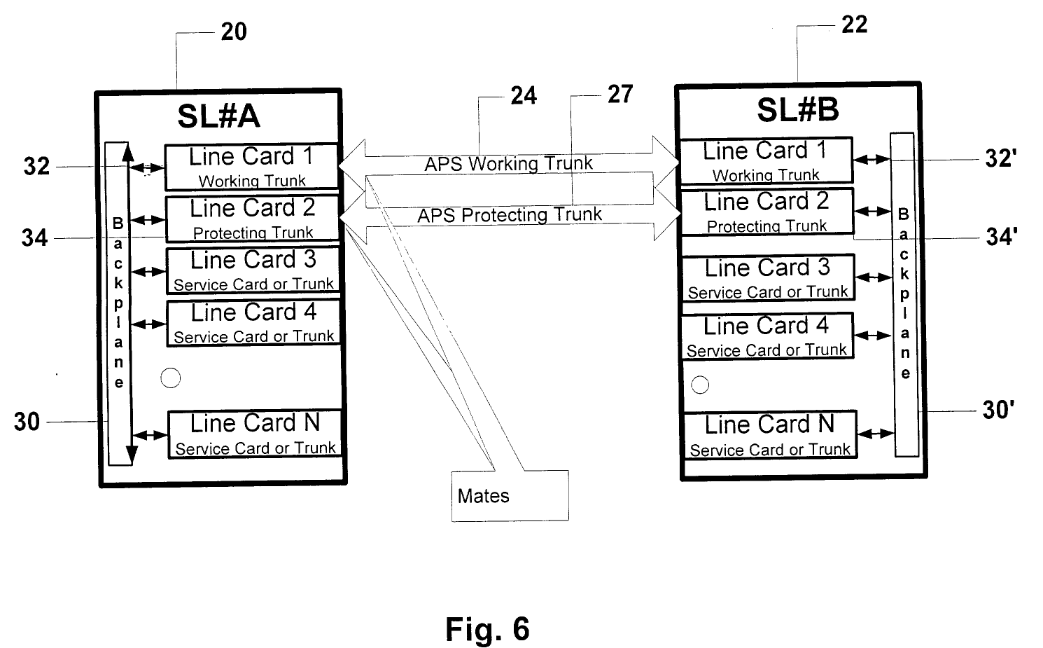

LINEAR APS. Referring now to FIG. 6, there is shown a schematic illustration of a linear protection scheme for a linear topology according to one embodiment of the invention, including a first network element (NE) 20 coupled to a second network element 22 by a first trunk 24 and a second trunk 27, trunk 27 providing protection to trunk 24. The protection protocol between the NEs is APS K-Byte, which is transported on the protecting trunk 27.

A backplane 30, 30′is provided inside each network element, coupled to all network element line cards including the working card 32, 32′and the protecting card 34, 34′. The internal network element protocol runs over the backplane.

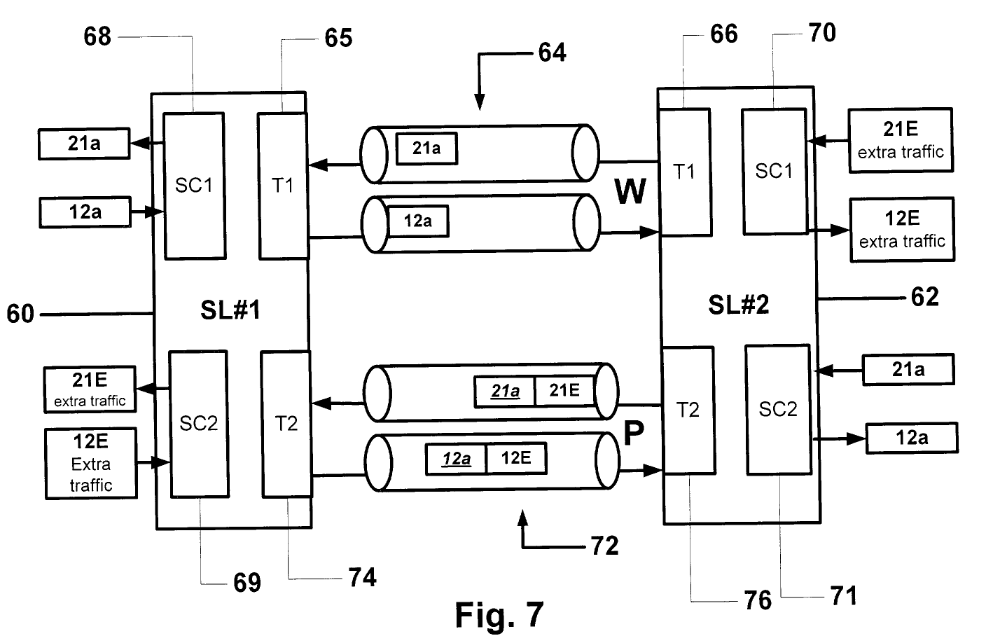

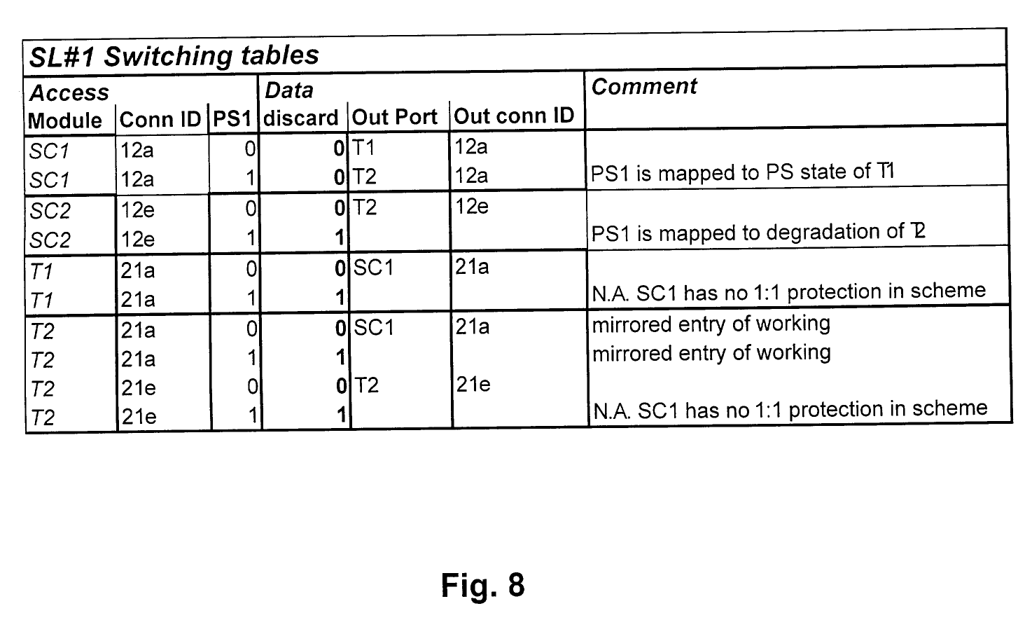

Referring to FIG. 7, there is shown an example of traffic transported over a linear sub network as described in FIG. 6. The associated Switching tables of SL#1 60 are shown in FIG. 8 (SL#2 tables are symmetrical). The sub-network includes a first network element (SL#1) 60 and a second network element (SL#2) 62. Network elements 60 and 62 are connected by a first trunk 64, which serves as a working trunk, by means of trunk cards 65 and 66. Network elements 60 and 62 are also connected by a second trunk 72, which serves as a protecting channel, by means of trunk cards 74 and 76.

A plurality of service cards, here illustrated as two service cards in each network element 68, 69, and 70, 71 are also mounted in the network elements. Protected services for transmission between network elements 60 and 62 are indicated as 12a and 21a. Extra traffic services, which are transmitted on the protected trunk as long as the protecting trunk does not need to perform PS, are indicated as 21E and 12E.

Operation of this sub-network is indicated by the entries in the associated switching table for network element 60 shown in FIG. 8. Thus, incoming services having a connection ID of 12a entering network element 60 via service card 68, in working state (0 appears in both the PS1 and PS2 columns in switching table), will be directed to the output port T1 in trunk card 65 with an output connection ID of 12a. This service travels over trunk 64 in the working trunk to an input port in trunk card 66 in network element 62. An additional switching table (not shown) indicates that a service with this connection ID is routed out via service card 71.

Similarly, an incoming service having a connection ID of 21a entering network element 62 via service card 71, in working state, is directed to the output port T1 in trunk card 64 with an output connection ID of 21a. This service travels over trunk 64 in the working trunk to an input port in trunk card 65 in network element 60. As seen in FIG. 8, this service with this connection ID is routed via service card 68 to its next destination.

Extra traffic having a connection ID of 12e entering network element 60 via service card 69, is directed, in the working state, to the output port T2 in trunk card 74 with an output connection ID of 12e, and travels over trunk 72 in the protecting trunk to an input port in trunk card 76 in network element 62.

Similarly, extra traffic having a connection ID of 21e entering network element 62 via service card 70, is directed, in the working state, to the output port T2 in trunk card 76 with an output connection ID of 21e, and travels over trunk 72 in the protecting trunk to an input port in trunk card 74 in network element 60.

In the switching table shown in FIG. 8, PS1 for connection 12a is mapped to Protection Switch (PS) of trunk 64 and PS1 for connection 12e is mapped to degradation of trunk 72.

Thus, an incoming service having a connection ID of 12a entering network element 60 via service card 68, in the presence of PS1 (PS1=1), is directed to the output port T2 in trunk card 74. This service travels over trunk 72 in the protecting trunk to an input port in trunk card 76 in network element 62. Trunk 76 routes this service, as in the working state, via service card 71 to its next destination, since it mirrors the working trunk connections besides the extra traffic connections.

Similarly, an incoming service having a connection ID of 21a entering network element 62 via service card 71, in the presence of PS1 (PS 1=1), is directed to the output port T2 in trunk card 76. This service travels over trunk 72 in the protecting trunk to an input port in trunk card 74 in network element 60. Trunk 74 routes this service, as in the working state, via service card 69 to its next destination, since it mirrors the working trunk connections besides the extra traffic connections.

In case of Protection Switch (PS), extra traffic must be discarded. Thus, an incoming service having a connection ID of 12e entering network element 60 via service card 69, in the presence of PS1 (which is mapped to Trunk 72 degradation), is discarded (Discard=1). Similarly, an incoming service having a connection ID of 21e entering network element 62 via service card 70, in the presence of PS1 (Trunk 72 degradation), is discarded (Discard=1).

For ring configurations, the present invention supports among others packet BLSR architecture (two fibers, four fibers) with the following SONET BLSR properties:

1) The protection is bi-directional, meaning that if one direction activates a Protection Switch, then Protection Switch is also actuated in the other direction.

2) Line protection is provided.

3) Possibility of transporting extra traffic on the protecting channel, for example, on a Best Effort protection basis, which is dropped in case of failure in the system.

4) The conventional SONET failure detection, identification and the BLSR K byte protocol is utilized. Thus, K1, K2 data are transmitted between all nodes in both directions. The usage of extra traffic is also announced through K1, K2.

5) In the Protecting Switch state, the edge nodes wrap around working traffic away from the failed link, i.e., all traffic that should have been transmitted on the failed link is transmitted on its protecting mate, as explained below.

6) In two fibers BLSR, half of the available BW in each trunk is reserved for working and half for protecting

It is a particular feature of this embodiment, that the working and protecting channels are determined by bandwidth allocation: one half of the available trunk bandwidth is reserved for working, and the other half is reserved for protection. Thus, bandwidth allocated for protected services is always available, even if there is a failure in the working trunk. This bandwidth allocation replaces the SONET allocation in the time domain, of the first half of STS as working and the second half as protecting.

It is a further feature of the present invention that when wrap around occurs, the packets are “colored”. An uncolored packet is a regular working packet. A colored packet, known as “P-mode” packet, is a packet that belongs in the protecting trunk, At least one bit in the tag attached to the packet indicates the “coloring”. Working packets, whose route encountered a failed ring link, are given color in the failure edge nodes upon wrap around, and transmitted as P-mode packets. The P-mode indication provides the capability of routing this packet along the ring, even though this connection does not appear in the switching tables. Rather, an entry for packets tagged with P-mode, regardless of their connection ID, exists in the switching table and indicates that such packets are to be routed around the ring. Packets marked as “P-mode” packets arriving to a ring node are passed along the ring. During wrap around, Extra traffic packets are discarded from the service cards (which are the traffic source) and the trunks, according to the switching table pre-configuration.

The Protection Switch layer is similar to the linear architecture (shown in FIG. 7 above), with the following changes. Failure detection and K-byte protocol in the ring embodiment of the present invention are identical to SONET BLSR (GR.1230) (instead of GR 253 in the linear). Therefore, the K-byte in the ring is received from both directions, specifies the node ID, and contains a few more protocol messages.

In case of PS, Network Degradation Indication will be set in all the ring trunks. If any of the nodes participating in the ring is in Protection Switch, Protection Switch indication will be set only in the failure edge nodes, in the ring′s trunks.

When failure in a Network Element is discovered, its adjacent nodes, after communicating with each other over K-byte according to GR.1230, switch to the Protection Switch state, and the network elements involved indicate that Protection Switch (PS) is taking place. In the PS state, traffic is transported over the mate trunk, protecting the failed trunk in each of the failure edge nodes.

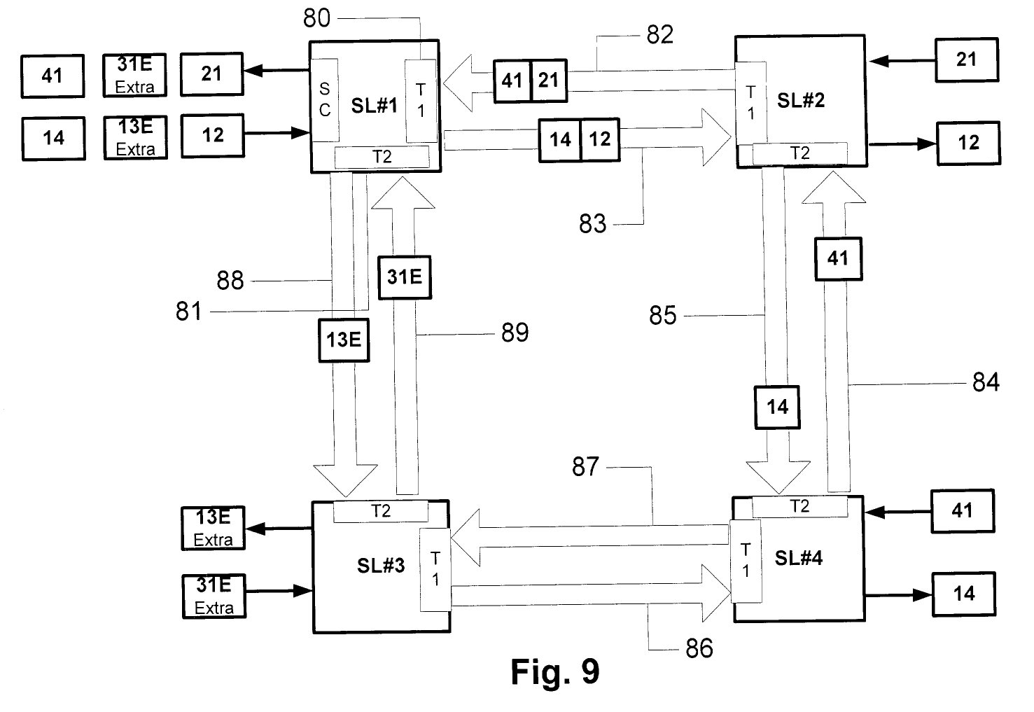

FIG. 9 illustrates an example of BLSR ring protection according to one embodiment of the present invention, in the working mode. As can be seen in FIG. 9, each network element SL#1, SL#2, SL#3, and SL#4 is coupled to the other network elements by trunks 82-83, 84-85, 86-87, 88-89. T1 and T2 (80 and 81 in SL#1) are mates. All trunks are logically divided into a working channel and a protecting channel, each channel being allocated one half the available bandwidth. For example, in a trunk of OC-48c, the working channel will consist of 1.25 Giga bps, and the protecting channel of 1.25 Giga bps.

When all nodes are functioning as they should, incoming services 14 and 12 entering network element SL#1 travel through trunk 83 to network element SL#2, which is the destination of services 12. Thus, services 12 are output towards their final destination, while services 14 continue around the ring over trunk 85 to their destination network element SL#4. Similarly, services 41 input in network element SL#4 are transmitted over trunk 84 through network element SL#2, where input services 21 are added. Services 41 and 21 are transmitted over trunk 82 to their network element destination SL#1, from which they are transmitted towards their final destination. In case there is extra traffic going one direction or the other, here shown as 13E and 31E, the extra traffic will be transmitted using the protecting channel bandwidth, here using protecting bandwidth of trunks 88 and 89.

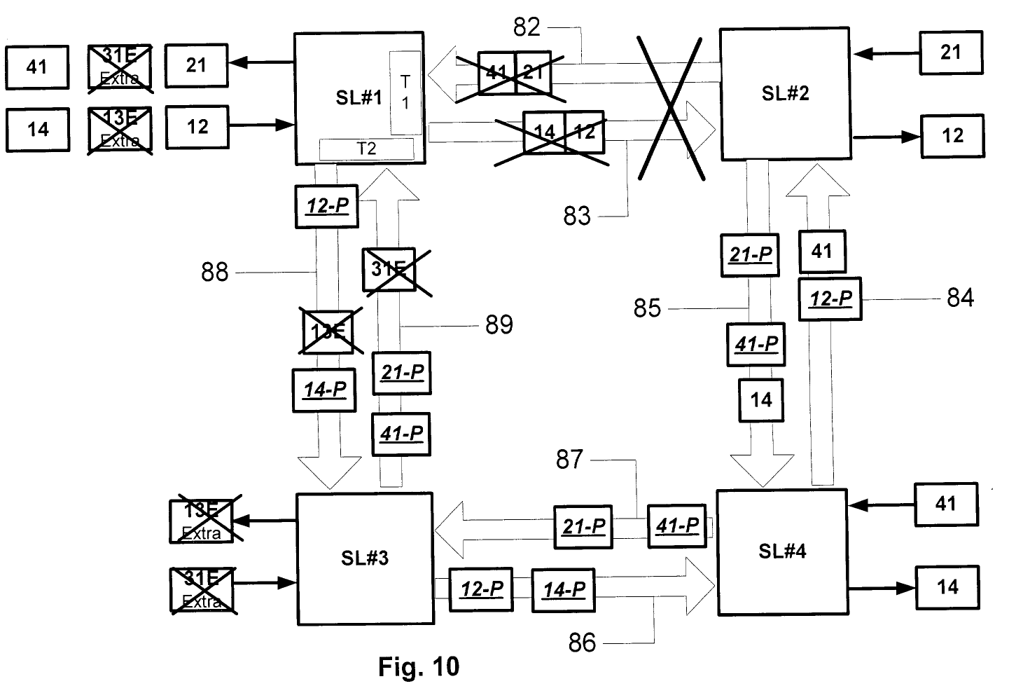

FIG. 10 illustrates the same ring in Protection Switch (PS) state, when a fiber is cut between network elements SL#1 and SL#2. Connection 12 entering network element SL#1 is routed through trunk 88 (instead of trunk 83) and marked as P-mode. Network element SL#3 passes 12-P along the ring through trunk 86 via network element SL#4, which also passes 12-P along the ring, to network element SL#2, where it leaves the ring. Note that network elements SL#3 and SL#4 do not contain connection 12 in their switching table, but due to the P-mode indication, pass the traffic through along the ring. Connection 14 is handled similarly, as illustrated.

Connections 13E and 31E, which are extra traffic, are discarded at the entrance to the ring. Connection 41 entering SL#4 is routed through trunk 84, as in the working state, and wrapped around in network element SL#2 over trunk 85, and marked as P-mode. When 41-P re-enters network element SL#4 via trunk 85, and since it is P-mode, it is passed through SL#4 and routed along the ring through trunk 87 and SL#3 over trunk 89 to SL#1, where it exits the ring. Here, too, connection 41 does not appear in the switching table of SL#4 via trunk 85 or SL#3, but due to P-mode, is passed through along the ring.

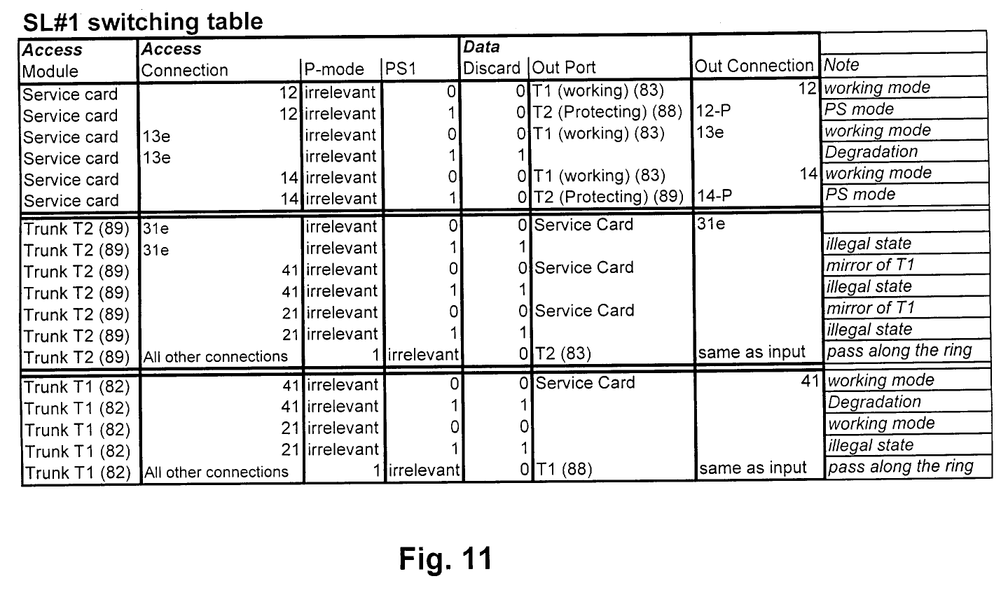

The above described routes are set according to the switching tables. An 10 example of a switching table according to one embodiment of the invention for network element SL#1 is shown in FIG. 11. As can be seen, indicators (e.g., PS1) are mapped for the various connections. For example, in the illustrated embodiment, for connection 12, PS1 is mapped to trunk 88 performing Protection Switch over trunk 83. In other words, the various events for which the indicator will be activated are pre-defined.

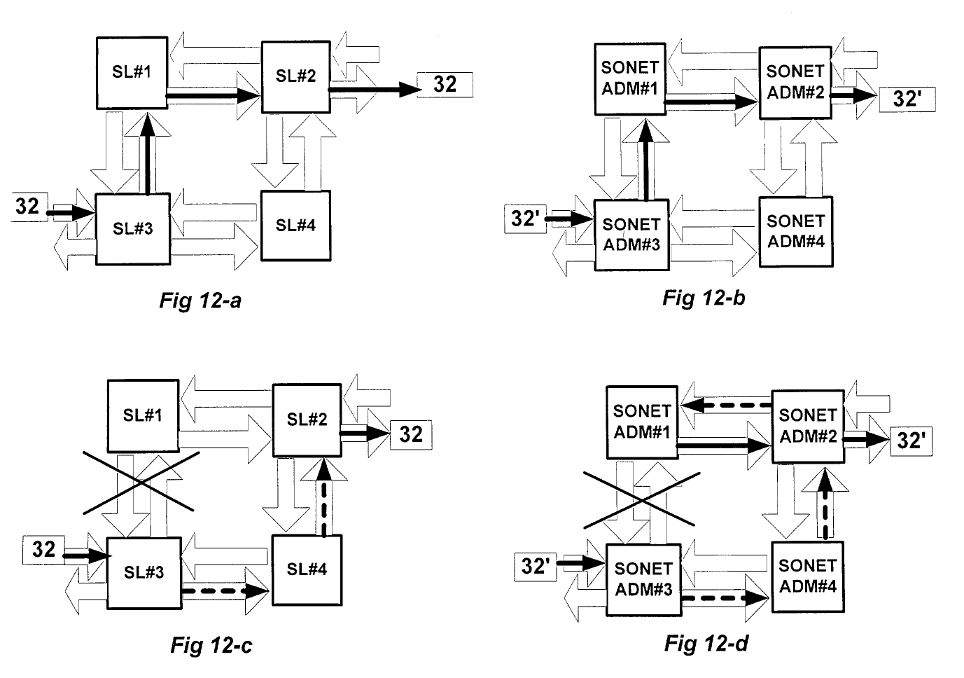

It should be noted that the average Protection Switch route length in the present invention is an improvement over that of conventional SONET. Since the switching table of a trunk must contain the connection of its mate (FIG. 11), the route length under PS avoids passing through the destination node and then returning to it, as illustrated schematically. FIG. 12a illustrates a service routed from network element SL#1 to network element SL#2 in working state. The route consists of two hops. FIG. 12b illustrates the same service in a conventional SONET network. The route also consists of two hops. FIG. 12c illustrates this service route in Protection Switch, which occurred due to a fiber cut between network elements SL#1 and SL#2. The route remains two hops, but the traffic is transported on the protection channel (dashed line). FIG. 12d illustrates conventional SONET network Protection Switch which occurred due to the same fiber cut. The route consists of four hops: SONET ADM#3 to SONET ADM#4 on the protection channel (dashed line), SONET ADM#4 to SONET ADM#2 on the protection channel, SONET ADM#2 to SONET ADM#1 on the protection channel, and SONET ADM#1 back to SONET ADM#2 on the working channel.

Another advantage of the present invention is the capability to use the protecting channel bandwidth for best effort services or traffic with Best Effort portions, such as SLA, when in the working state. In the protecting state, the Best effort will use less bandwidth automatically, since less bandwidth is available at the network. This is due to the fact that, according to the invention, if a packet is of known connection, even though it is in “P-mode”, it is terminated (i.e., treated according to switching table information when it reaches a node on whose switching table it appears). In SONET, on the other hand, STS which are reserved for protection are not terminated—rather, they are transported along the ring and wrapped around at the edges.

The protection system of the present invention is particularly useful for packets processed according to Applicant′s co-pending patent applications, U.S. Ser. No. 09/753,400 and Ser. No. 09/753,399. Thus, where several wavelengths are utilized for various services, it is possible to define the level of protection of the wavelength. In other words, one or more wavelengths can be granted full protection, while others can be provided with “best effort” protection, as desired. Alternatively, the services inside the connections (equivalent to SONET internal channels) can be selected for varying levels of protection.

The solution of the present invention can comply with both SDH (Synchronous Digital Hierarchy) MS-Spring (multi-shared) and SONET BLSR rings.

It will be appreciated that the invention is not limited to what has been described hereinabove merely by way of example. Rather, the invention is limited solely by the claims which follow.

1. A method for protecting packets which include services, transported over an optical communication network, against traffic loss of more than 50 milliseconds, the method comprising:
selecting a sub-network of the network;
defining a protection scheme in the sub-network;
utilizing a standard protocol for failure detection and identification and protection;
defining connections between an A side and a Z side in the network, passing through at least one selected network element in said sub-network;
automatically adding entries in switching tables of said selected network elements for a working state of said sub-network connections; and
adding pre-defined entries in said switching tables for a protection state for each network element in the sub-network.

2. The method according to claim 1, and further including adding pre-defined entries to said switching table for each network element for selected alternative states of the sub-network.

3. The method according to claim 2, wherein said step of adding entries includes adding entries to said switching table for each network element for degradation state.

4. The method according to claim 2, wherein said step of adding entries includes adding entries to said switching table for discarding extra traffic.

5. The method according to claim 1, further comprising actuation of Protection Switch for at least some of said network elements in said sub-network upon failure identification of a network element in said sub-network by means of a standard protocol; and
wherein actuation of Protection Switch includes selecting an already existing protection path pre-defined in a switching table.

6. The method according to claim 1, wherein said step of utilizing a standard protocol includes using APS and K1, K2 from a conventional SONET/SDH protocol for identification of traffic failure/degradation, and for actuation of protection state.

7. The method according to claim 1, wherein total bandwidth of said sub-network is divided into a working channel and a protecting channel and, during Protection Switch traffic to a failed network element is transmitted in said protecting channel.

8. The method according to claim 7, wherein transmitting traffic in said protecting channel includes coloring a packet containing said traffic to permit said packet to pass through network elements for which said packet does not appear in their switching tables.

9. The method according to claim 7, wherein extra traffic is transmitted over said protecting channel during working, and discarded during Protection Switch.

10. A method for protecting services transported in packets over an optical communication network against traffic loss of more than 50 milliseconds, the method including:
selecting a sub-network of the network;
defining at least one protection scheme in the sub-network utilizing any standard protection protocol;
defining connections, through at least one network element in the sub-network, for transport of traffic between selected service ports in the network;
for every connection, pre-defining entries for working state in switching tables of all network elements the connection passes through;
for every connection, pre-defining protection level; and
for every protected connection, pre-defining entries in said switching tables of all network elements the connection passes through for protection switch states according to the defined protection scheme.

11. The method according to claim 10, wherein said protection level is selected from protected, unprotected, degraded rate, “extra traffic”, and combinations of these.

12. A system for providing protection for services transmitted over an optical communication network from an A-side to a Z-side against traffic loss of more than 50 milli-seconds, the system comprising
a sub-network including a plurality of network elements;
at least one connection between said A-side and said B-side passing through at least one network element in said sub-network;
a switching table indicating a working state for each said connection; and
at least one Protection Switch indicator including at least one entry in the switching table indicating a pre-defined protection path between each two network units.

13. The system according to claim 12, further comprising:
at least two mates in each network element
a protocol operating between said two mates in each network element to manage and activate protection switch; and
a protocol between all line cards to distribute the Protection Switch and the network Protection Switch Indicators

14. The system according to claim 13, wherein said protocol includes APS/BLSR and K1, K2 from a conventional SONET/SDH protocol.

15. The system according to claim 12, wherein said plurality of network elements form a linear sub-network.

16. The system according to claim 12, wherein said plurality of network elements form a ring sub-network.

17. The system according to claim 12, wherein said plurality of network elements form a mesh sub-network, which is a combination of ring and linear.

18. The system according to claim 12, wherein each said network element includes at least one trunk card, at least one service card, and a bus physically connecting said trunk cards and said service cards.

19. The system according to claim 12, wherein total bandwidth of said sub-network is divided into a working channel and a protecting channel and, during Protection Switch, traffic to a failed channel is transmitted in said protecting channel.

20. The system according to claim 12, wherein said switching table includes entries for transmitting extra traffic over said protecting channel during working, and entries for discarding said extra traffic during Protection Switch.
